(19) United States
(12) Patent Application Publication
(10) Pub. No.: US 2009/0129725 A1
(43) Pub. Date: May 21, 2009

(54) SFP Active fiber patch cord with over-molded strain relief and conductive housing

(76) Inventors: Richard C.E Durrant, Algonquin, IL (US); Anthony Kowalkowski, Chicago, IL (US); Bruce Peterson, Schaumburg, IL (US)

Correspondence Address: Karl D. Kovach, Esq.;Emerson Network Power, Connectivity Solutions, Inc, Suite 308N, 300 Lakeside Drive, Bannockburn, IL, 60015, US

(21) Appl. No.: 12/313,326

(22) Filed: Nov. 19, 2008

Related U.S. Application Data
(60) Provisional application No. 61/003,940, filed on Nov. 20, 2007.

(51) Int. Cl. G02B 6/12

(52) U.S. Cl. 385/14

(57) ABSTRACT

The device includes a first optical fiber, a second optical fiber, a first transmitting optical subassembly, a second transmitting optical subassembly, a first receiving optical subassembly, a second receiving optical subassembly, a first circuit board, a second circuit board, a first amount of over-molding material, and a second amount of over-molding material.

This non-provisional application claims the priority of earlier filed U.S. Provisional Application Ser. No. 61/003,940, filed Nov. 20, 2007. U.S. Provisional Patent Application Ser. No. 61/003,940 is hereby incorporated herein by reference.

### BACKGROUND OF THE INVENTION

1. Field of the Invention

The present invention pertains to patch cord devices. The invention more particularly concerns an active patch cord having a Small Form Factor Pluggable (SFP) compatible transceiver at each end of the cord.

2. Discussion of the Background

Small Form Factor Pluggable (SFP) transceivers are known in the art. Such transceivers are disclosed in U.S. Pat. Nos. 6,778,399; 6,570,768; 6,556,445; 6,551,117; and 6,430,053. U.S. Pat. Nos. 6,778,399; 6,570,768; 6,556,445; 6,551,117; and 6,430,053 are hereby incorporated herein by reference. The specific standards for SFP transceivers are set forth in the “Small Form-Factor Pluggable (SFP) Transceiver Multisource Agreement (MSA),” dated Sep. 14, 2000.

Patch cords are also known in the art. Known patch cords include patch cords which are terminated with LC style connectors. LC style connectors are well known in the art. The patch cord is a passive device.

In practice the situation may arise where two host devices need to communicate with one another. Often, both host devices include ports which accept SFP transceivers. In such an instance, one SFP transceiver is plugged into one of the host devices and a second SFP transceiver is plugged into the second host device. The two SFP transceivers are then connected to one another via a patch cord, where the patch cord is terminated at each end with LC style connectors. Thus, the two host devices can transmit and receive signals between each other.

### SUMMARY OF THE INVENTION

The invention provides for a one-piece solution for routing signals from one SFP port to another. The invention replaces the known two standard SFP transceivers and one LC patch cord. Thus, the one-piece solution increases the ease with which two host devices can be connected. Additionally, inventory costs are reduced, and interconnection problems are reduced.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of one end of the patch cord during one of the initial stages of construction of the optoelectronic device of the invention;

FIG. 2 is a perspective view of the device of FIG. 1 as shown during another stage of construction;

FIG. 3 is a perspective view of the device of FIG. 2 as shown during yet another stage of construction;

FIG. 4 is a perspective view of the device of FIG. 3 as viewed from a different perspective angle;

FIG. 5 is a perspective view of the device of FIG. 3 as shown during still yet another stage of construction;

FIG. 6 is a perspective view of the device of FIG. 5 as viewed from a different perspective angle; and

FIG. 7 is a perspective view of the completely constructed device.

### DETAILED DESCRIPTION OF THE PRESENTLY PREFERRED EMBODIMENT

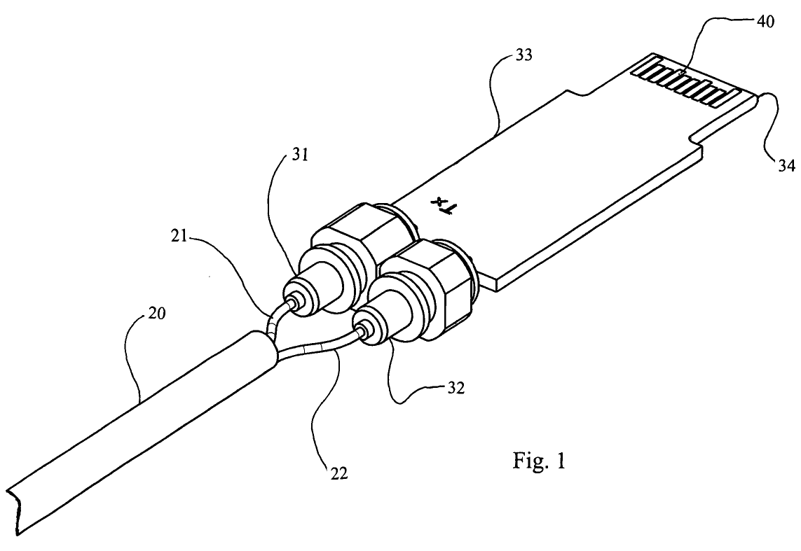

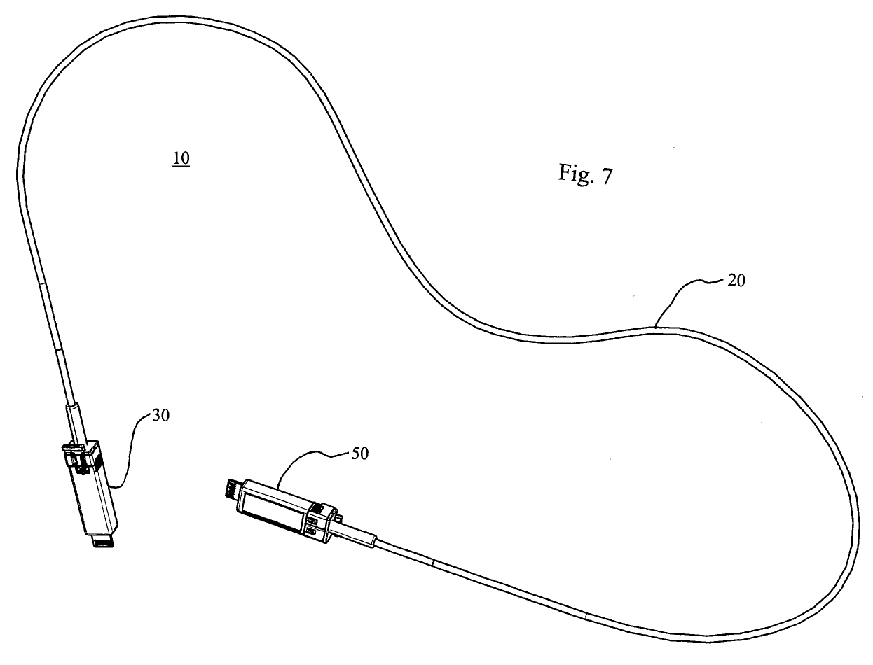

Referring now to the drawings, wherein like reference numerals designate identical or corresponding parts through the several views, an embodiment of the present invention is displayed therein. The device 10, as displayed in FIG. 7, provides a user with the ability to connect one host device to another device utilizing a one-piece solution. The device 10, as disclosed in FIG. 7, includes a first transceiver 30 connected to a second transceiver 50 via an optical cable 20. FIGS. 1-6 display various intermediate steps of construction of the device 10. The device 10 can also be referred to as an active patch cord.

FIG. 1 is a perspective view which discloses the major components of the first transceiver 30 during construction of the device 10 at one end of the patch cord. Attached mechanically and electrically to a circuit board 33 are a transmitting optical subassembly 31 and a receiving optical subassembly 32. A first optical fiber 21 of an optical cable 20 is attached to the transmitting optical subassembly 31 so that the optical fiber 21 is in optical communication with the transmitting optical subassembly 31. A second optical fiber 22 of the optical cable 20 is attached to the receiving optical subassembly 32 so that the optical fiber 22 is in optical communication with the receiving optical subassembly 32. A portion of the circuit board 33 is formed into a card edge connector 34. The card edge connector 34 contains contact traces 40. The card edge connector 34 is in electrical communication with the transmitting optical subassembly 31 and the receiving optical subassembly 32. The circuit board 33 contains electrical signal conditioning components which are not shown. Electrical signal conditioning components include an amplifier to be used in conjunction with the receiving optical subassembly 32, and a laser driver to be used in conjunction with the transmitting optical subassembly 31.

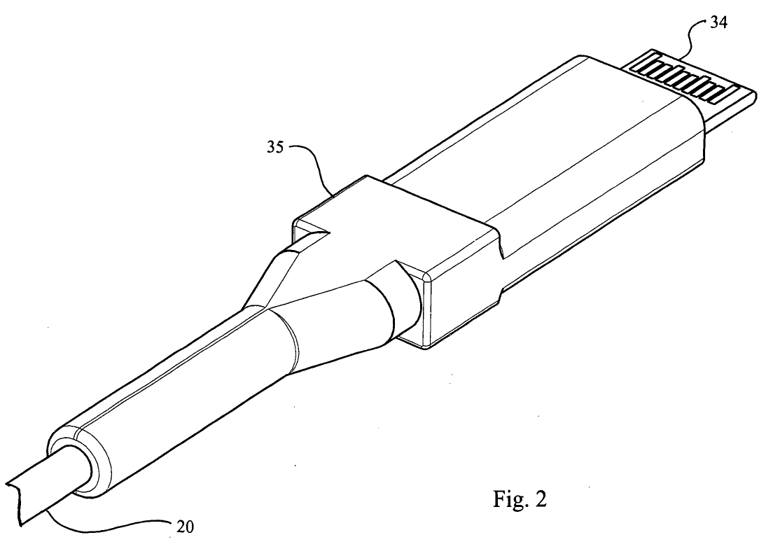

FIG. 2 is a perspective view of the first transceiver 30 of FIG. 1 which discloses an additional component which has been added during the further construction of the device 10. An over-molding material 35 has been injection-molded around the exposed optical fibers 21, 22, the transmitting optical subassembly 31, the receiving optical subassembly 32, and a majority of the circuit board 33. However, the card edge connector 34 is still exposed.

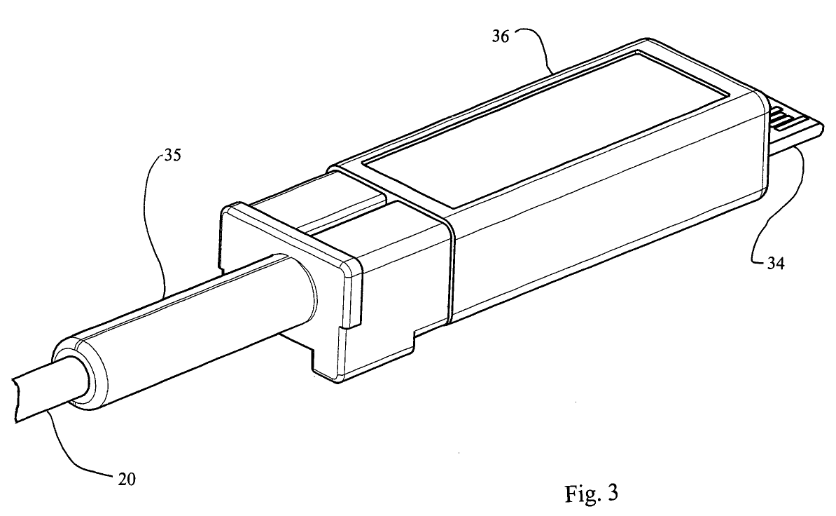

FIG. 3 is a perspective view of the first transceiver 30 of FIG. 2, wherein the device is shown still yet further along in its construction. A conductive outer housing 36 has been injection-molded around and attached to the over-molding material 35 so as to cover and give a form to the first transceiver 30 of the device 10 so that the first transceiver 30, including the card edge connector 34, will be accepted by a port of a host device where such a port accepts a standard SFP transceiver. Functionally, as far as the port of the host device is aware, the first transceiver 30 of the device 10 is functionally equivalent to a standard SFP transceiver. The material of the conductive outer housing 36 is different than the material of the over-molding material 35. As an alternative, the outer conductive housing 36 can be a separate, non-injection-molded, conductive part or parts which are attached to the over-molding material 35.

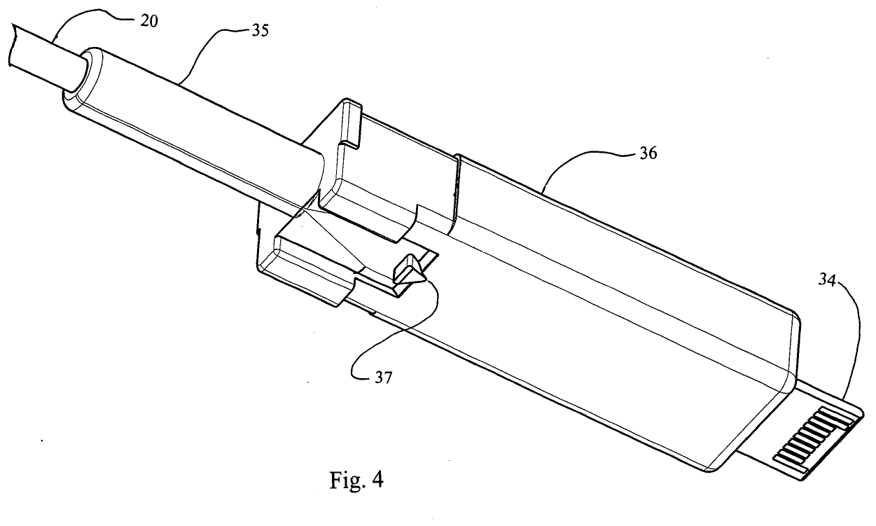

FIG. 4 is a perspective view of the first transceiver 30 of FIG. 3 as viewed from a different perspective angle. Disclosed is a locking tab 37 which is part of the over-molding material 35. The locking tab 37 is used to secure the device 10 to the port of the host device in the same way as a standard SFP is secured to the port of the host device.

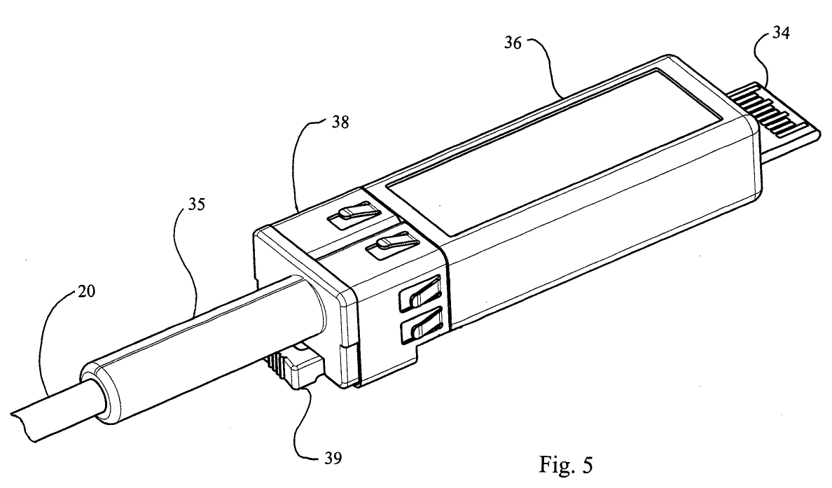

FIG. 5 is a perspective view of the first transceiver 30 of FIG. 3 wherein the device is shown further along in its construction and includes a ground clip 38, and a release lever 39. Ground clips 38, release levers 39, and locking tabs 37 are disclosed in U.S. Pat. Nos. 6,220,878; 6,570,768; and 6,556,445. U.S. Pat. Nos. 6,220,878; 6570,768; and 6,556,445 are hereby incorporated herein by reference.

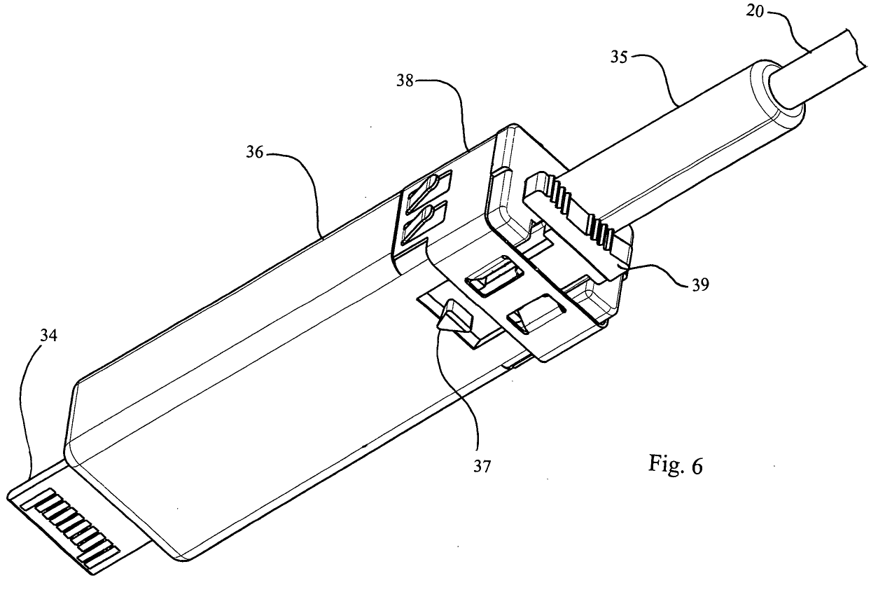

FIG. 6 is a perspective view of the first transceiver 30 of FIG. 5 as viewed from a different perspective angle.

The second transceiver 50 is constructed nearly the same as the first transceiver 30. The differences being as follows: the first optical fiber 21 which is connected to the transmitting optical subassembly 31 of the first transceiver 30 at one end of the first optical fiber 21 is in optical communication at the other end of the first optical fiber 21 with the receiving optical subassembly of the second transceiver 50; and the second optical fiber 22 which is connected to the receiving optical subassembly 32 of the first transceiver 30 at one end of the second optical fiber 22 is in optical communication at the other end of the second optical fiber 22 with the transmitting optical subassembly of the second transceiver 50. Thus, FIG. 7 is a perspective view of the compete device 10 which includes the two SFP style transceivers attached to the patch cord.

The device 10 of the invention eliminates the connection between the prior art SFP transceivers and the LC connectors of the patch cord. By removing the separable fiber ferrule connections of the known patch cord to the known SFP transceivers, the active patch cord of the invention essentially guarantees optical transmission unhindered by contaminants such as dust and moisture.

The inner stage of the over-molded construction, which utilizes the over-molding material 35, of the SFP-style ends of the active patch cord 10 provides a flexible strain relief for the optical fiber 21, 22 as they exit the housing while electrically insulating the electronics of the circuit board 33 from the conductive polymer of the conductive outer housing 36. It also environmentally seals the optical interface and electronics, thus providing protection from moisture, and contaminants, and further provides protection from shock and vibration.

The outer over-molded stage of conductive polymer 36 provides rugged protection for the module end and further provides EMI shielding for the internal electronics. Also, for reduction of components, the ground clip 38 serves the dual purposes of grounding the module to the cage of the port of the host device, and securing the one-piece actuator or release lever 39 to the housing 36.

Thus, Applicants' invention, as compared to the known art, reduces the number of components required to connect two SFP ports, since Applicants' device is a one-piece solution for routing signals from one SFP port to another.

Obviously, numerous modifications and variations of the present invention are possible in light of the above teachings. It is therefore to be understood that within the scope of appended claims, the invention may be practiced otherwise than as specifically described herein.

1. A device comprising:
a first optical fiber having a first end and a second end;
a second optical fiber having a third end and a fourth end;
a first transmitting optical subassembly attached to the first end of the first optical fiber;
a second transmitting optical subassembly attached to the fourth end of the second optical fiber;
a first receiving optical subassembly attached to the second end of the first optical fiber;
a second receiving optical subassembly attached to the third end of the second optical subassembly;
a first circuit board attached to the first transmitting optical subassembly and to the first receiving optical subassembly;
a second circuit board attached to the second transmitting optical subassembly and to the second receiving optical subassembly;
a first amount of over-molding material surrounding the first transmitting optical subassembly and the first receiving optical subassembly; and
a second amount of over-molding material surrounding the second transmitting optical subassembly and the second receiving optical subassembly.

2. A device according to claim 1 wherein the first circuit board includes a first card edge connector, and the second circuit board includes a second card edge connector.

3. A device according to claim 2 wherein the first card edge connector includes a first set of contact traces, and wherein the second card edge connector contains a second set of contact traces.

4. A device comprising:
a first optical fiber having a first end and a second end;
a second optical fiber having a third end and a fourth end;
a first transmitting optical subassembly attached to the first end of the first optical fiber;
a second transmitting optical subassembly attached to the fourth end of the second optical fiber;
a first receiving optical subassembly attached to the second end of the first optical fiber;
a second receiving optical subassembly attached to the third end of the second optical subassembly;
a first circuit board attached to the first transmitting optical subassembly and to the first receiving optical subassembly;
a second circuit board attached to the second transmitting optical subassembly and to the second receiving optical subassembly;
a first amount of over-molding material surrounding the first transmitting optical subassembly and the first receiving optical subassembly;
a second amount of over-molding material surrounding the second transmitting optical subassembly and the second receiving optical subassembly;
a first housing attached to the first amount of over-molding material, wherein the first housing is conductive; and
a second housing attached to the second amount of over-molding material, wherein the second housing is conductive.

5. A device according to claim 4 wherein the first circuit board includes a first card edge connector, and the second circuit board includes a second card edge connector.

6. A device according to claim 5 wherein the first card edge connector includes a first set of contact traces, and wherein the second card edge connector contains a second set of contact traces.

7. A device comprising:
a first optical fiber having a first end and a second end;
a second optical fiber having a third end and a fourth end;
a first transmitting optical subassembly attached to the first end of the first optical fiber;
a second transmitting optical subassembly attached to the fourth end of the second optical fiber;
a first receiving optical subassembly attached to the second end of the first optical fiber;
a second receiving optical subassembly attached to the third end of the second optical subassembly;
a first circuit board attached to the first transmitting optical subassembly and to the first receiving optical subassembly;
a second circuit board attached to the second transmitting optical subassembly and to the second receiving optical subassembly;
a first amount of over-molding material surrounding the first transmitting optical subassembly and the first receiving optical subassembly;
a second amount of over-molding material surrounding the second transmitting optical subassembly and the second receiving optical subassembly;
a first housing attached to the first amount of over-molding material, wherein the first housing is conductive;
a second housing attached to the second amount of over-molding material, wherein the second housing is conductive;
a first ground clip attached to the first housing; and
a second ground clip attached to the second housing.

8. A device according to claim 7 wherein the first circuit board includes a first card edge connector, and the second circuit board includes a second card edge connector.

9. A device according to claim 8, further comprising a first release lever mechanically associated with first housing and the first ground clip, and a second release lever mechanically associated with the second housing and the second ground clip.

10. A device according to claim 9 wherein the first card edge connector includes a first set of contact traces, and wherein the second card edge connector contains a second set of contact traces.
